(19) United States
(12) Patent Application Publication
(10) Pub. No.: US 2016/0004982 A1
(43) Pub. Date: Jan. 7, 2016

(54) METHOD AND SYSTEM FOR ESTIMATING THE PROGRESS AND COMPLETION OF A PROJECT BASED ON A BAYESIAN NETWORK

(71) Applicant: INTERNATIONAL BUSINESS MACHINES CORPORATION, ARMONK, NY (US)

(72) Inventors: Murray R. Cantor, Westwood, MA (US); Evelyn Duesterwald, Pleasantville, NY (US); Tamir Klinger, Brooklyn, NY (US); Stanley M. Sutton, JR., Briarcliff Manor, NY (US); Peri L. Tarr, Briarcliff Manor, NY (US)

(21) Appl. No.: 14/323,317

(22) Filed: Jul. 3, 2014

(51) Int. Cl. G06Q 10/06; G06N 7/00

(52) U.S. Cl. CPC G06Q 10/06; G06N 7/005

(57) ABSTRACT

A method for projecting the progress of a project, the project including work items, the method including: obtaining starting state transition probabilities for the work items in a first time interval; obtaining starting populations of the work items, wherein the starting populations of the work items include states of the work items at the beginning of the first time interval; determining expected distributions for the work item states at the end of the first time interval by using the starting state transition probabilities and the starting populations; identifying actual states for the work items at the end of the first time interval; determining actual state transition rates of the work items for the first time interval by using the starting populations and the actual states; and determining expected future state transition probabilities for the work items by using the starting state transition probabilities and the actual state transition rates.

### 1. TECHNICAL FIELD

The present invention relates to managing development projects, and more particularly, to monitoring the progress of a software development project.

### 2. DISCUSSION OF THE RELATED ART

An important aspect of the management of a development project is monitoring the progress of the project to assess whether it is on schedule and whether it is likely to complete on time.

### BRIEF SUMMARY

In an exemplary embodiment of the present invention, there is provided a method for projecting the progress of a project, over one or more time intervals, the project including a plurality of work items, the method comprising: obtaining starting state transition probabilities for the work items in a first time interval; obtaining starting populations of the work items, wherein the starting populations of the work items include states of the work items at the beginning of the first time interval; determining expected distributions for the work item states at the end of the first time interval by using the starting state transition probabilities and the starting populations; identifying actual states for the work items at the end of the first time interval; determining actual state transition rates of the work items for the first time interval by using the starting populations and the actual states; and determining expected future state transition probabilities for the work items by using the starting state transition probabilities and the actual state transition rates.

The starting state transition probability of a particular work item is the probability that the state of that work item at the beginning of the first time interval will transition to another state at the end of the first time interval.

In determining the actual state transition rates of the work items, it is determined how many work items having a first state at the beginning of the first time interval actually transition to a second state at the end of the first time interval.

An expected future state transition probability for a particular work item is the probability that that work item having a first state at the beginning of a second time interval will have a second state at the end of the second time interval.

The method further comprising: obtaining starting state transition probabilities for the work items in a second time interval, wherein the starting state transition probabilities are the expected future state transition probabilities as determined for the first time interval; obtaining starting populations for the work items in the second time interval, wherein the starting populations include the actual states for the work items at the end of the first time interval; determining expected distributions for the work item states at the end of the second time interval by using the starting state transition probabilities of the second time interval and the starting populations of the second time interval; identifying actual states for the work items at the end of the second time interval; determining actual state transition rates of the work items for the second time interval by using the starting populations of the second time interval and the actual states at the end of the second time interval; and determining new expected future state transition probabilities for the work items by using the starting state transition probabilities of the second time interval and the actual state transition rates of the second time interval.

The method further comprising determining the progress of the project by using the actual state transition rates of the work items for the second time interval.

The work items are divided into a plurality of groups and the method is applied independently to these groups.

Determining expected distributions for the work item states at the end of the first time interval further comprises determining states of new work items added to the project during the first time interval.

The project is a software development project.

In an exemplary embodiment of the present invention, there is provided a method for projecting the progress of a project, over one or more time intervals, the project including a plurality of work items, the method comprising: computing actual state transition rates of the work items for a first time interval by using starting populations of the work items and actual states of the work items at the end of the first time interval, wherein the starting populations of the work items include states of the work items at the beginning of the first time interval; and computing expected future state transition probabilities for the work items by using starting state transition probabilities of the work items and the actual state transition rates, wherein the starting state transition probability of a particular work item is the probability that the state of that work item at the beginning of the first time interval will transition to another state at the end of the first time interval.

The method further comprising: computing new expected future state transition probabilities for the work items by using starting state transition probabilities of the work items for a second time interval and actual state transition rates of the work items for the second time interval, wherein the starting state transition probabilities of the work items for the second time interval are the expected future state transition probabilities computed for the first time interval.

The actual state transition rates for the work items for the second time interval are computed using the actual states for the work items at the end of the first time interval.

In an exemplary embodiment of the present invention, there is provided a method for projecting the progress of a project, wherein the project is represented as a collection of work items, each work item having an associated discrete state, the method comprising: (a) for each ordered pair of state values, determining, as an initial state transition probability, a probability that a work item having a first state at the start of a first interval will have a second state at the end of the first interval; (b) identifying the state associated with each of the work items at the start of the first interval; (c) constructing an initial distribution of the work item states for the first interval; (d) projecting an expected distribution of the work items states at the end of the first interval using the state associated with each of the work items at the start of the first interval as identified in (b) and the initial state transition probabilities as determined in (a); (e) identifying actual states of the work items at the end of the first interval; (f) for each ordered pair of the state values, determining, as an actual state transition rate, a proportion of the work items with the first state at the start of the first interval that have the second state at the end of the first interval; and (g) for each ordered pair of the state values, determining, as an expected state transition probability, a probability that a work item having the first state at the start of a second interval will have the second state at the end of the second interval by using the initial state transition probabilities and the actual state transition rates.

The method further comprising: repeating (a-g) for the second interval, wherein the expected state transition probabilities are used as the initial state transition probabilities in (a) and the actual states of the work items at the end of the first interval are used as the states in (b).

A work item state is indicative of an aspect of specific past, present or future work.

Progress of the project is measured by a change in the work item states.

Projecting the expected distribution of the work items states at the end of the first interval in (d) further uses additional information that may affect the expected distribution of the work item states at the end of the first interval.

The additional information includes expected future trends in characteristics of the work items and expected future trends in other conditions that may affect the expected distribution of the work item states at the end of the first interval.

For each ordered pair of the state values, determining, as the expected state transition probability in (g) further uses additional information that may affect the expected state transition probabilities.

The additional information includes expected future trends in characteristics of the work items and expected future trends in other conditions that may affect the expected state transition probabilities.

### BRIEF DESCRIPTION OF THE SEVERAL VIEWS OF THE DRAWINGS

FIG. 1 illustrates a flowchart of a method for estimating the progress and completion of a project based on a Bayesian network according to an exemplary embodiment of the present invention; and

FIG. 2 illustrates an apparatus for implementing an exemplary embodiment of the present invention.

### DETAILED DESCRIPTION

The invention disclosed herein is capable of tracking and projecting the progress of a project in any engineering discipline. As a non-limiting example, the invention may be used to track and project the progress of projects in the software engineering domain. As another non-limiting example, the invention may be used to track and project the progress of projects in the civil engineering or computer engineering domains. In doing this, the invention focuses on the states of project tasks and on the transitions of a task from one state to another.

It is to be understood that many representations of project tasks incorporate some notion of the state of the task. The state of a task is usually taken to represent the status of the task with respect to its progress and completion. For example, at its simplest, a task may be considered either “Not Done” or “Done”; a slightly more complicated set of tasks may be “Available”, “Started”, and “Completed”. If the work of a task may be performed intermittently, then the task may have a “Suspended” state. If a task may be invalidated, then the task may have an “Invalid” state. If the outcome of a task is subject to review, then the task may have states “Pending Review”, “Accepted”, and “Rejected”. In a version of the bug-tracking system Bugzilla, tasks represent software bugs that generally need to be fixed, and the states that may be associated with a bug include “Unconfirmed”, “New”, “Assigned”, “Reopened”, “Ready” and “Resolved”.

Usually, the set of possible states that is associated with a task represents a notion of a “life cycle”. Tasks will typically start in one initial state or in one subset of initial states, finish in another state and subset of states, and in between follow a path through a sequence of states that may be more or less typical or expected. For instance, in the simplest case mentioned above, a task will start as “Not Done” and end as “Done”. A task with a somewhat more elaborate set of states may have a life cycle represented by a longer sequence of states such as “Available”, “In Progress”, “Suspended”, “In Progress”, and “Completed”. In Bugzilla, a representative sequence of states representing the life cycle of a bug-fixing task is “Unconfirmed”, “New”, “Assigned”, “Resolved”, and “Verified”. Note that the sequence of states may be more or less constrained and that different sequences of states may be possible for tasks within a particular state set. The progression of a task through a set of states can be gauged with respect to a particular state sequence such as may be defined by a life cycle. Additionally, the completion of a task may be taken to occur with the assignment of a final state to the task where such states may be defined with respect to a life cycle.

The inventive approach of focusing on task states and state transitions has two aspects that can mitigate challenges to tracking and projecting the progress of software development.

One aspect is that task state-transition data constitute a small, simple, and basic data set compared to the potentially large numbers and many kinds of task data and attributes that may be available in a modern software development project. It is usually easy for a developer to note when a task changes state, as this may require just a mouse click or two in a readily available graphical user interface. Additionally, developers may be motivated to enter this information because it shows their involvement with and progress on the tasks that are assigned to them. Additionally, information about task state-transitions may be obtainable automatically, from analysis of task properties, task relationships, work products, data about the project, data about the context of the project, and other sources that may be relevant, if such data are available. Finally, much of the other information that may be recorded and analyzed about tasks for purposes of tracking progress and projecting completion may be less useful if it cannot be interpreted in the context of information about task states and state transitions. For instance, it may be useful to know how much effort was expended on a task, which may be recorded as the actual effort associated with the task. However, it may be even more useful to know when the course of the project that effort was expended, which could be reflected in the history of task state transitions. As a result, information about task states and transitions is among the task-related data that a software development project is likely to collect.

The second aspect of the invention that can mitigate challenges to tracking and projecting the progress of software development is that the state-transition data provide a bottom-line view of the progress of the project. A project will be in progress to the extent that its tasks are in progress, and a project will be complete to the extent that its tasks are complete. The actual progress and completion of the project will be the result of many diverse and changing factors with complicated and dynamic interrelationships. The invention avoids modeling these factors and interrelationships by simply looking at their combined effects in the actual progress and completion of a project.

The invention disclosed herein makes use of information about task states and state transitions, as well as accommodating the use of additional information, by means of a Bayesian network.

It is to be understood that a Bayesian network is a directed acyclic graph in which the nodes represent random variables and the directed arcs define causal influences or statistical or functional relationships. Nodes without parents in the graph are defined through probability distributions. Nodes with parents in the graph are defined through conditional probability distributions. The conditional probability distributions may be defined through deterministic functions of their parents or through standard probability distribution functions.

The use of a directed acyclic graph is appropriate for making the contributing data entities (nodes) and computations (arcs) explicit and for clearly representing the interrelationships of data and computations. The view of data entities as random variables is consistent with the stochastic and dynamic nature of task states and state transitions as they appear in reality and reflects the probabilistic computations that the invention incorporates. The ability to incorporate both deterministic and probabilistic computation is used to accommodate the diversity of computations that the method may entail.

Now that the invention has been discussed in brief, a more detailed description follows.

As mentioned above, the invention operates to produce a projection of the progress and completion of a project that consists of a collection of tasks. The tasks will typically entail work to be done as part of the project and will require time and effort.

The tasks are given an informational representation, such as in an automated processing system, that is apart from and independent of the actual embodiment of the task, for example, in work performed by a person. It is possible to associate the informational representation of a task with its actual embodiment, where such exists, although a representation of a task may be created for work that is to be performed in the future or for work that has been performed in the past.

In the remainder of this description, references to “task” or “tasks” will generally mean the informational representation of the tasks rather than the actual embodiments of the tasks, except where noted otherwise.

Each task has a distinct identity and an associated state attribute (or just “state”) that takes on one of a known set of discrete values. The state values represent aspects of the conduct or status of the embodied task that are significant with respect to the progress and completion of the project. For instance, the status values associated to a task may represent significant aspects of the progress and completion of the embodied task. Additionally, tasks change state from time to time, and these changes in state typically represent and correlate with significant changes in the conduct or status of the embodied task.

The invention utilizes the availability of a history of task state changes, and for each such change in task state it is possible to determine the initial state, the final state and a time for the transition. This information is available in the history of each task.

As the invention produces a projection of the progress and completion of a project in terms of the progress and completion of its tasks, the invention may be used in a context where the tasks of a project do make overall progress of some sort and may attain a condition of completion defined in some respect. However, the invention may operate under conditions where the tasks may not make overall progress and the completion of the project may not be attainable or even defined. A utility of the invention under these conditions may be to describe or discover patterns or conditions in the state transitions of the project tasks or to track and project conditions other than completion for the project.

The invention considers task states and state transitions at intervals. For instance, at the start of an interval, the invention projects a distribution of task states for the end of the interval, given the population of tasks at the beginning of the interval and given a table of the probabilities of specific state transitions for those tasks. Similarly, the invention compares the given table of state-transition probabilities for an interval to the actual state-transition rates for the interval. The duration of the interval does not matter, although the invention may be used when the intervals are scaled so that several may occur over the expected duration of the project. In practice, the duration of the intervals may be constant during the course of a project but this is not a requirement of the invention. In more detail, intervals may be determined with various characteristics, such as having a fixed duration, having a variable duration, being synchronous with respect to the project schedule and project milestones, being asynchronous with respect to the project schedule and project milestones, and other characteristics relating to duration and synchronization.

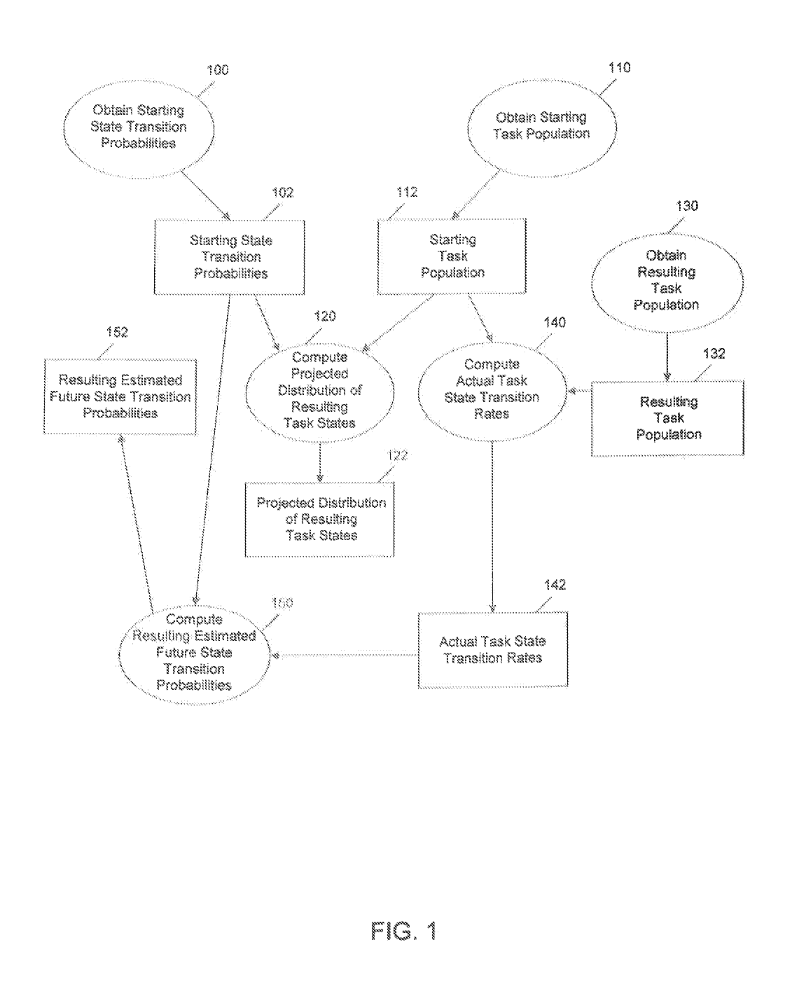

The following paragraph gives an overview of the basic method of the invention, as illustrated in FIG. 1.

The method of the invention comprises two aspects, one that applies within an interval, the other that applies between successive intervals. The aspect of the method that applies with an interval is illustrated in FIG. 1. In the step at 100, the starting set of task state-transition probabilities is obtained; these probabilities are shown at 102. In the step at 110, the starting population of tasks is obtained; this starting population, e.g., the informational representations of the actual task embodiments, is shown at 112. At step 120, the distribution of task states that is projected to occur at the conclusion of the interval is computed. Step 120 uses the state-transition probabilities shown at 102 and the states of the starting task population shown at 112 and produces the projected distribution of resulting task states shown at 122. At step 130, the population of tasks resulting at the conclusion of the interval is obtained; this population of tasks is shown at 132. At step 140, the actual state transition rates for tasks resulting at the conclusion of the interval is calculated. This step uses the actual population of tasks resulting at the conclusion of the interval, shown at 132 and produces the actual state transition rates, shown at 142. At step 150, the resulting expected future state transition probabilities are computed. This step uses the actual state transition rates, shown at 142 and the starting state-transition probabilities, shown at 102, and this step produces the resulting estimated future state-transition probabilities, shown at 152.

The following paragraph explains the iteration of the basic method.

The aspect of the method that applies between intervals can be explained as follows with further reference to FIG. 1. After the conclusion of one interval following step 150, a decision can be made as to whether to terminate the method or continue it. If a decision is made to continue the method, then the sequence of steps 100 to 150 is repeated. When the method is repeated in this way, the results of the preceding interval can be carried forward into the succeeding interval. In particular, the step 100 of obtaining the starting set of task state-transition probabilities can be accomplished by taking the results of the previous execution step 150, namely the estimated future state transition probabilities. Additionally, the step 110 of obtaining the starting task population is accomplished by taking the result of the previous execution step 130, namely the resulting task population of the completed iteration.

The following series of paragraphs address the various ways that specific steps can be performed, describe alternative approaches thereof, as well as provide a simple example.

The step of obtaining the starting state-transition probabilities, shown as 100 in FIG. 1, can be performed in various ways. One way to obtain the probabilities is to use the estimated future state transition probabilities, as produced by step 150 in an execution of the method in a previous interval. If there has not been an execution of the method in a previous interval then the starting state-transition rates may be determined based on the recommendation of a person experienced with the method or with projects that are similar to the one to which the method will be applied. Additionally, in the case there has not been an execution of the method in a previous interval, the probabilities may be adopted from another project, or the probabilities may be taken from reports of user experiences or accepted practices in the industry, if such exist, or the probabilities may be obtained in some other manner. The previously listed approaches to obtaining the starting state transition probabilities when there has been no execution of the method in a previous interval can also be used when there has been an execution of the method in previous interval, with or without being combined with the results of a previous interval.

As an example, assume that we have a type of work item called “BugReport” and that a BugReport item has states “New”, “InProgress”, and “Fixed”. For step 100, the starting state transition probabilities for work items of type BugReport might be something like:

| Start State | End State | Probability |
|---|---|---|
| New | New | 0.70 |
| New | InProgress | 0.20 |
| New | Fixed | 0.10 |
| InProgress | New | 0.10 |
| InProgress | InProgress | 0.60 |
| InProgress | Fixed | 0.30 |
| Fixed | New | 0.10 |
| Fixed | InProgress | 0.10 |
| Fixed | Fixed | 0.80 |

It is to be understood that the states associated to work items may represent the stage of completion, phase of work, attainment of a milestone, or other characteristics of the amount, kind, or quality of work accomplished or not accomplished within the scope of the work item, for example.

The step of obtaining the starting task population, shown at 110, is not constrained by the invention and may be accomplished in any way consistent with an approach in practice to organizing, executing, and managing the project and an approach in practice to recording, maintaining, and managing information about project tasks.

A starting population of BugReports obtained in step 110 might be something like:

| Work Item | | Work Item | |
|---|---|---|---|
| Type | Work Item Id | State | Work Item Description |
| BugReport | 1 | Fixed | Program title is misspelled |
| | | | on splash . . . |
| BugReport | 2 | InProgress | Program crashes with more |
| | | | than 10 files . . . |
| BugReport | 3 | New | No spell checker for Japanese |
| | | | language |
| BugReport | 4 | New | . . . |
| BugReport | 5 | New | . . . |
| BugReport | 6 | New | . . . |
| BugReport | 7 | InProgress | . . . |
| BugReport | 8 | InProgress | . . . |
| BugReport | 9 | InProgress | . . . |
| BugReport | 10 | Fixed | . . . |

A distribution of starting states based on the above table might be something like:

| Work Item Type | Work Item State | Number of Work Items |
|---|---|---|
| BugReport | New | 4 |
| BugReport | InProgress | 4 |
| BugReport | Fixed | 2 |

The step 120 of computing the projected distribution of resulting task states is accomplished by applying the starting state transition probabilities, produced by step 100, to the states of the starting task population, produced by step 110, in order to produce the projected distribution of resulting task states from step 120. The starting probabilities may be applied one or more times to the starting task states and the projected distribution of resulting task states may be computed from one or more such applications of probabilities. By means of applying the starting probabilities one or more times to a given starting distribution of task states, the resulting distribution of task states to a corresponding number of intervals into the future may be projected.

In step 120, the projected occurrence of resulting task states might be computed as in the following table:

| | | | Number of | Projected |
|---|---|---|---|---|
| | | | Items | Number of Items |
| Start State | End State | Probability | in Start State | in End State |
| New | New | 0.7 | 4 | 3 |
| New | InProgress | 0.2 | 4 | 1 |
| New | Fixed | 0.1 | 4 | 0 |
| InProgress | New | 0.1 | 4 | 0 |
| InProgress | InProgress | 0.6 | 4 | 3 |
| InProgress | Fixed | 0.3 | 4 | 1 |
| Fixed | New | 0.1 | 2 | 0 |
| Fixed | InProgress | 0.1 | 2 | 0 |
| Fixed | Fixed | 0.8 | 2 | 2 |

Which give rise to the resulting projected distribution of work-item states:

| Work Item Type | Work Item State | Number of Work Items |
|---|---|---|
| BugReport | New | 3 |
| BugReport | InProgress | 4 |
| BugReport | Fixed | 3 |

The step of obtaining the resulting task population, shown at 130, is not constrained by the invention and may be accomplished in any way consistent with an approach in practice to organizing, executing, and managing the project and an approach in practice to recording, maintaining, and managing information about project tasks.

In step 130, we might find that the resulting actual occurrence of work-item states is the following:

| | | | Actual Number |
|---|---|---|---|
| | | Number of Items in Start | of Items in End |
| Start State | End State | State | State |
| New | New | 4 | 2 |
| New | InProgress | 4 | 2 |
| New | Fixed | 4 | 0 |
| InProgress | New | 4 | 0 |
| InProgress | InProgress | 4 | 4 |
| InProgress | Fixed | 4 | 0 |
| Fixed | New | 2 | 0 |
| Fixed | InProgress | 2 | 0 |
| Fixed | Fixed | 2 | 2 |

The step 140 of computing the actual state transition rates using the starting task population, as obtained in step 110, and the resulting task population, as obtained in step 130, may be accomplished in a way that directly and accurately reflects the numbers and proportions of state transitions that occurred for tasks represented in both the starting and resulting task populations.

In step 140, we would compute the actual transition rates from the above table as follows:

| | | | Actual Number | Actual State |
|---|---|---|---|---|
| | | Number of Items | of Items in End | Transition |
| Start State | End State | in Start State | State | Rate |
| New | New | 4 | 2 | 0.50 |
| New | InProgress | 4 | 2 | 0.50 |
| New | Fixed | 4 | 0 | 0.00 |
| InProgress | New | 4 | 0 | 0.00 |
| InProgress | InProgress | 4 | 4 | 1.00 |
| InProgress | Fixed | 4 | 0 | 0.00 |
| Fixed | New | 2 | 0 | 0.00 |
| Fixed | InProgress | 2 | 0 | 0.00 |
| Fixed | Fixed | 2 | 2 | 1.00 |

The step 150 of computing the resulting state transition probabilities is accomplished in consideration of the starting state transition probabilities, as obtained in step 100, and the resulting state transition rates, as computed in step 140. The resulting state transition probabilities may be computed by the step at 150 in various ways, including adopting or adapting the starting state transition probabilities, by adopting or adapting the resulting state transition probabilities, or by combining and adapting the starting and resulting state transition probabilities, such as by taking their average, or by taking a weighted average, or by some other means.

In step 150, the expected future state transition probabilities are computed. For example, this might be done by taking the average of the expected transition probabilities and the actual transition rates for the previous interval:

| | | | | Future |
|---|---|---|---|---|
| | | Prior Expected | | Expected |
| | | Transition | Actual Prior | Transition |
| Start State | End State | Probability | Transition Rate | Probability |
| New | New | 0.70 | 0.50 | 0.60 |
| New | InProgress | 0.20 | 0.50 | 0.35 |
| New | Fixed | 0.10 | 0.00 | 0.05 |
| InProgress | New | 0.10 | 0.00 | 0.05 |
| InProgress | InProgress | 0.60 | 1.00 | 0.80 |
| InProgress | Fixed | 0.30 | 0.00 | 0.15 |
| Fixed | New | 0.10 | 0.00 | 0.05 |
| Fixed | InProgress | 0.10 | 0.00 | 0.05 |
| Fixed | Fixed | 0.80 | 1.00 | 0.90 |

The following series of paragraphs address elaborations of the method.

The method of the invention incorporates further refinements and extensions of the method as discussed above in relation to FIG. 1.

The step of computing the resulting state transition probabilities, shown at 150, can consider the starting state transition probabilities, as obtained or computed in step 100, and actual state transition rates, as computed in step 140, from more than one prior interval. For example, in 150, the actual state transition rates may be considered alone, such as by adoption of the actual state transition rate as the expected state transition probabilities, or the initial state transition probabilities may be considered alone, such as by adoption of the initial state transition probabilities as the expected state transition probabilities, or the actual state transition rates may be considered in combination with the initial state transition probabilities, such as by adopting their average as the expected state transition probabilities. Further, step 150 can consider one or more of the immediately prior intervals, or it can consider all of the prior intervals, or it can consider a subset of prior intervals that are selected according to criteria based on the intervals, the tasks, the project or other sources of information. The step can combine information from prior intervals in various ways, including taking averages, taking weighted averages, or using other mathematical techniques. The other mathematical techniques can include applications of Bayes' theorem. The choice of mathematical techniques can be made manually (e.g., by people) or automatically. The process of choosing mathematical techniques can incorporate machine-learning algorithms. Additionally, the step can make various selections of the different information that may be available from prior intervals, such as using only the starting state transition probabilities, or using only the actual state transition rates, or using a combination of these.

The step of computing the resulting state transition probabilities, shown at 150, can consider additional information, not shown in FIG. 1, in addition to or instead of the starting state transition probabilities, as computed in step 100, and the actual resulting state transition rates, as computed in step 140, in FIG. 1. For instance, the step of computing the resulting state transition probabilities can take into account the stage of work in the project, the kind or qualities of work associated with the stage of the project, the state of the project and its tasks with respect to the project schedule and milestones, the state of the project and its tasks with respect to the project resources, changes in the number, types, and characteristics of tasks, expected future trends in the number, types, and characteristics of the tasks, expected future trends in the pace, focus, time, effort, and other characteristics of work activities, and other considerations in the project and the context of the project.

The step of computing the projected resulting task state distribution, shown at 120, can consider additional information, not shown in FIG. 1, in addition to or instead of the starting state transition probabilities, as obtained in step 100, and the starting task population, obtained in step 110, in FIG. 1. For instance, the step of computing the projected resulting task state distribution can take into account the stage of work in the project; the kind or qualities of work associated with the stage of the project; the state of the project and its tasks with respect to the project schedule milestones; the state of the project and its tasks with respect to the project resources; changes in the number, types, and characteristics of tasks; expected future trends in the number, types, and characteristics of the tasks; expected future trends in the pace, focus, time, effort, and other characteristics of work activities, and other considerations in the project and the context of the project. As a consequence of the consideration of this information and for other reasons, the process of computing the projected resulting task state distribution may include a fixed or a variable number of opportunities for a task to make a state transition, and the number of opportunities for a task to make a state transition may be determined in various ways, such as deterministically, probabilistically, and stochastically.

The method of the invention as described above and illustrated in FIG. 1 can be applied independently to different groups of tasks within a single project. The progress and completion of each group of tasks can be projected individually, and the progress and completion of the project as a whole can be determined based on consideration of the overall progress and completion of its constituent groups of tasks. The groups of tasks within the project may be defined for any purpose relevant to the project or its management, including by the type of tasks; by the assignment of personnel and resources to the tasks; by the nature and location of work represented by the tasks; by various attributes that may be associated with the tasks, such as priority, risk, expected duration, and others; by the recommendations of an expert agent; and by the efficacy of the grouping for purposes of representing, monitoring, and projecting the progress and completion of the tasks; and by other considerations. Additionally, the division of tasks into groups may be performed prior to or during the execution of the project, and later divisions of tasks into groups may or may not be constrained by earlier divisions of tasks into groups. Additionally, any information that is used to divide tasks into groups may be obtained before the execution of the project and it may or may not depend on the execution of the project.

The step of the method of the invention which entails projecting the expected distribution of work item states at the end of the interval (shown as 120 in FIG. 1) can also include projecting the occurrence and states of additional work items that are expected to be newly created for or added to the project during the interval over which the projection is made. Projections of the occurrence and states of additional work items can be based on one or more kinds of information relating to one or more prior iterations of the method; information relating to characteristics of the population of work items; information relating to the project, for example, the project stage, project schedule, or project resources; information relating to expected future trends in the number, types, and characteristics of the tasks; information relating to expected future trends in the pace, focus, time, effort, and other characteristics of work activities; and information relating to the context of the project. Additionally, the method of projecting the occurrence and states of additional work items can be based on more than one prior iteration of the method and can entail the combination of information from prior iterations according to a mathematical function that may be a simple average, a weighted average, and other mathematical functions. Additionally, the way in which the one or more prior iterations that are considered for purposes of projecting the occurrence and states of additional work items can be selected in various ways, such as by considering all prior iterations, and by considering one or more of the most recent prior iterations, and by considering a set of prior iterations determined by some other criterion.

The following discussion is provided to relate the method to Bayesian nets.

Note that FIG. 1, in terms of which the method of the invention is described in detail above, constitutes an alternative representation of a Bayesian network. As traditionally represented, the nodes in a Bayesian network stand for variables (or data entities) and the arcs stand for functions (or computations). In FIG. 1, for purposes of this disclosure, a complementary approach is used for representing the network. The functions by which variables are related in a Bayesian network are represented by rounded nodes, and the variables are the outputs of the functions, which may flow along the arcs between the functions (e.g., the outputs of one function may become the inputs to another function). Some function nodes have no ancestors, e.g., no incoming arcs, such as the node for obtaining the starting task population (labeled 110 in FIG. 1). Such nodes represent the computations (or other activities) by which the prior values or probability distributions of initial variables are set, such as the starting task population (obtained by step 100 in FIG. 1). Some of the functional nodes represent deterministic functions, such as the node for computing the actual task state transition rates (labeled 140 in FIG. 1). Some of the functional nodes represent probabilistic functions, such as the node for computing the projected distribution of resulting task states (labeled 120 in FIG. 1). By these sorts of representations, FIG. 1 has an interpretation as a Bayesian network that is a concise and effective way of describing and organizing the elements of the method of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

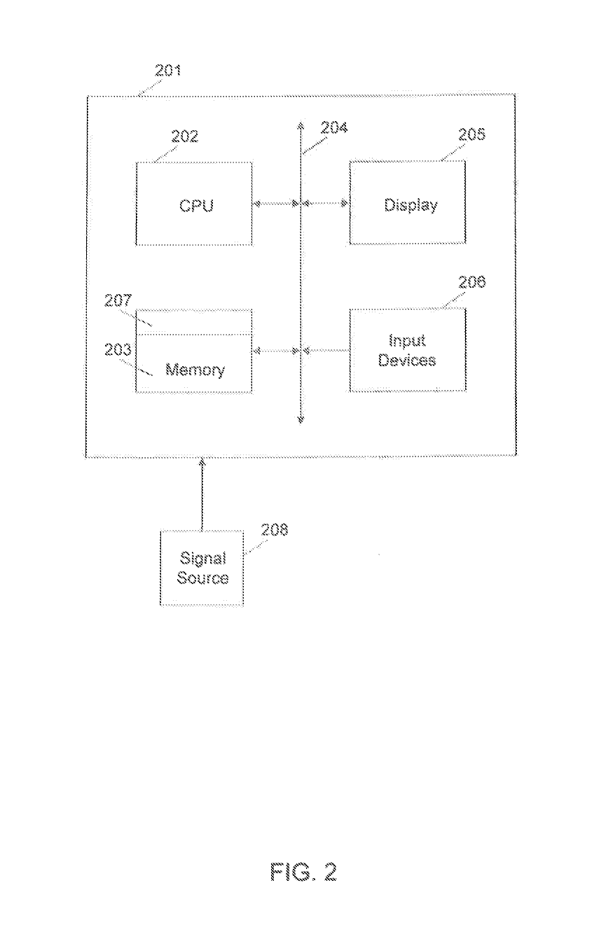

Referring now to FIG. 2, according to an exemplary embodiment of the present invention, a computer system 201 can comprise, inter alia, a CPU 202, a memory 203 and an input/output (I/O) interface 204. The computer system 201 is generally coupled through the I/O interface 204 to a display 205 and various input devices 206 such as a mouse and keyboard. The support circuits can include circuits such as cache, power supplies, clock circuits, and a communications bus. The memory 203 can include RAM, ROM, disk drive, tape drive, etc., or a combination thereof. Exemplary embodiments of present invention may be implemented as a routine 207 stored in memory 203 (e.g., a non-transitory computer-readable storage medium) and executed by the CPU 202 to process the signal from the signal source 208. As such, the computer system 201 is a general-purpose computer system that becomes a specific purpose computer system when executing the routine 207 of the present invention.

The computer platform 201 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for projecting the progress of a project, over one or more time intervals, the project including a plurality of work items, the method comprising:
obtaining starting state transition probabilities for the work items in a first time interval;
obtaining starting populations of the work items, wherein the starting populations of the work items include states of the work items at the beginning of the first time interval;
determining expected distributions for the work item states at the end of the first time interval by using the starting state transition probabilities and the starting populations;
identifying actual states for the work items at the end of the first time interval;
determining actual state transition rates of the work items for the first time interval by using the starting populations and the actual states; and
determining expected future state transition probabilities for the work items by using the starting state transition probabilities and the actual state transition rates.

2. The method of claim 1, wherein the starting state transition probability of a particular work item is the probability that the state of that work item at the beginning of the first time interval will transition to another state at the end of the first time interval.

3. The method of claim 1, wherein in determining the actual state transition rates of the work items, it is determined how many work items having a first state at the beginning of the first time interval actually transition to a second state at the end of the first time interval.

4. The method of claim 1, wherein an expected future state transition probability for a particular work item is the probability that that work item having a first state at the beginning of a second time interval will have a second state at the end of the second time interval.

5. The method of claim 1, further comprising:
obtaining starting state transition probabilities for the work items in a second time interval, wherein the starting state transition probabilities are the expected future state transition probabilities as determined for the first time interval;
obtaining starting populations for the work items in the second time interval, wherein the starting populations include the actual states for the work items at the end of the first time interval;
determining expected distributions for the work item states at the end of the second time interval by using the starting state transition probabilities of the second time interval and the starting populations of the second time interval;
identifying actual states for the work items at the end of the second time interval;
determining actual state transition rates of the work items for the second time interval by using the starting populations of the second time interval and the actual states at the end of the second time interval; and
determining new expected future state transition probabilities for the work items by using the starting state transition probabilities of the second time interval and the actual state transition rates of the second time interval.

6. The method of claim 5, further comprising:
determining the progress of the project by using the actual state transition rates of the work items for the second time interval.

7. The method of claim 1, wherein the work items are divided into a plurality of groups and the method is applied independently to these groups.

8. The method of claim 1, wherein determining expected distributions for the work item states at the end of the first time interval further comprises determining states of new work items added to the project during the first time interval.

9. The method of claim 1, wherein the project is a software development project.

10. A method for projecting the progress of a project, over one or more time intervals, the project including a plurality of work items, the method comprising:
computing actual state transition rates of the work items for a first time interval by using starting populations of the work items and actual states of the work items at the end of the first time interval,
wherein the starting populations of the work items include states of the work items at the beginning of the first time interval; and
computing expected future state transition probabilities for the work items by using starting state transition probabilities of the work items and the actual state transition rates,
wherein the starting state transition probability of a particular work item is the probability that the state of that work item at the beginning of the first time interval will transition to another state at the end of the first time interval.

11. The method of claim 10, further comprising:
computing new expected future state transition probabilities for the work items by using starting state transition probabilities of the work items for a second time interval and actual state transition rates of the work items for the second time interval,
wherein the starting state transition probabilities of the work items for the second time interval are the expected future state transition probabilities computed for the first time interval.

12. The method of claim 11, wherein the actual state transition rates for the work items for the second time interval are computed using the actual states for the work items at the end of the first time interval.

13. A method for projecting the progress of a project, wherein the project is represented as a collection of work items, each work item having an associated discrete state, the method comprising:
(a) for each ordered pair of state values, determining, as an initial state transition probability, a probability that a work item having a first state at the start of a first interval will have a second state at the end of the first interval;
(b) identifying the state associated with each of the work items at the start of the first interval;
(c) constructing an initial distribution of the work item states for the first interval;
(d) projecting an expected distribution of the work items states at the end of the first interval using the state associated with each of the work items at the start of the first interval as identified in (b) and the initial state transition probabilities as determined in (a);
(e) identifying actual states of the work items at the end of the first interval;
(f) for each ordered pair of the state values, determining, as an actual state transition rate, a proportion of the work items with the first state at the start of the first interval that have the second state at the end of the first interval; and
(g) for each ordered pair of the state values, determining, as an expected state transition probability, a probability that a work item having the first state at the start of a second interval will have the second state at the end of the second interval by using the initial state transition probabilities and the actual state transition rates.

14. The method of claim 13, further comprising:
repeating (a-g) for the second interval, wherein the expected state transition probabilities are used as the initial state transition probabilities in (a) and the actual states of the work items at the end of the first interval are used as the states in (b).

15. The method of claim 13, wherein a work item state is indicative of an aspect of specific past, present or future work.

16. The method of claim 13, wherein progress of the project is measured by a change in the work item states.

17. The method of claim 13, wherein projecting the expected distribution of the work items states at the end of the first interval in (d) further uses additional information that may affect the expected distribution of the work item states at the end of the first interval.

18. The method of claim 17, wherein the additional information includes expected future trends in characteristics of the work items and expected future trends in other conditions that may affect the expected distribution of the work item states at the end of the first interval.

19. The method of claim 13, wherein for each ordered pair of the state values, determining, as the expected state transition probability in (g) further uses additional information that may affect the expected state transition probabilities.

20. The method of claim 19, wherein the additional information includes expected future trends in characteristics of the work items and expected future trends in other conditions that may affect the expected state transition probabilities.
